(19) United States
(12) Patent Application Publication
(10) Pub. No.: US 2022/0273998 A1
(43) Pub. Date: Sep. 1, 2022

(54) DETECTING METHOD OF GOLF CLUB AND SENSING DEVICE USING THE SAME

(71) Applicant: GOLFZON CO., LTD., Seoul (KR)

(72) Inventor: Hyun Jin PARK, Daejeon (KR)

(73) Assignee: GOLFZON CO., LTD., Seoul (KR)

(21) Appl. No.: 17/630,941

(22) PCT Filed: Jul. 24, 2020
(86) PCT No.: PCT/KR2020/009760

§ 371 Date: Jan. 28, 2022

(30) Foreign Application Priority Data
Jul. 30, 2019 (KR) 10-2019-0092460

(51) Int. Cl. A63B 60/46; G06V 10/60; G06V 10/46; G06T 7/66

(52) U.S. Cl. CPC A63B 60/46; G06V 10/60; G06V 10/46; G06T 7/66; A63B 2220/807; A63B 2102/32

(57) ABSTRACT

The present invention is to provide a method for detecting a golf club and a sensing device using the same, and provides a new method for detecting the golf club from an image captured by the sensing device. The present invention provides a method for accurately analyzing movement characteristics such as bending of a golf club by accurately detecting the shape of the golf club during golf swing by analyzing the shadow of the golf club formed on the floor in the captured image rather than directly detecting the golf club from the captured image.

### TECHNICAL FIELD

The present invention relates to a sensing device for sensing movement of a golf club during a golf swing and a method for detecting the golf club by the sensing device.

### BACKGROUND ART

Recently, various simulators and devices have been actively developed that allow users to enjoy popular sports events such as baseball, soccer, basketball, and golf in the form of interactive sports simulation based on simulation technology indoors or in a specific place.

In particular, in recent years, a so-called screen golf system has been appeared. When a user holds a golf club and swings and hits a golf ball on the hitting mat, the sensing device detects the moving golf ball and golf club, and the physical properties of the moving golf ball are calculated using the detection result. Based on the calculated physical characteristics, the trajectory of the ball is simulated on a virtual golf course. Accordingly, a technology that allows users to enjoy real golf in virtual reality is being developed.

For simulation of sports using balls such as golf is performed through such an interactive sports simulator, research and development on various sensing systems for accurately detecting physical properties of moving balls are being actively conducted.

For example, various sensing methods such as sensing devices using infrared sensors, sensing devices using laser sensors, sensing devices using acoustic sensors, and sensing devices using camera have been appeared. In particular, in order to accurately sense the state of the moving ball, research on a camera sensor type sensing device that acquires and analyzes an image of the moving ball has been actively conducted.

In the case of a camera-based sensing device, the position of the ball and the position of the golf club should be specified through the image acquired by the camera, respectively. However, unlike the method of specifying the position of the ball, golf clubs have quite a variety of sizes, shapes, colors, and materials, so it is very difficult to fully extract and recognize golf clubs from images.

To solve this problem, a technology has emerged to attach a specific marker to a club shaft or club head of a golf club, find the specific marker in the captured image, and specify the location of the golf club. However, there is a fatal problem in that the user must use a special golf club with a specific marker when practicing golf or playing virtual golf. In addition, even if a specific marker is attached to the golf club, the marker is often not fully displayed or covered on the image containing the scene of the golf swing, making it difficult to specify the exact location of the golf club.

To solve this problem, a technology for detecting a golf club disclosed in prior art documents such as Patent Application No. 10-2011-0025149, Patent Application No. 10-2016-0064881, and Patent Application No. 10-2016-0156308 has been developed.

The technology for detecting golf clubs disclosed by the above prior art literature was to regard golf clubs as straight lines because it was difficult for users to extract golf clubs from images acquired when swinging golf. For example, using techniques such as Hough Transform, a linear component was detected in the image, and the detected linear component was regarded as a club shaft of a golf club to analyze information on the movement of the golf club during a golf swing.

As shown in FIG. 1(a), when the user performs a golf swing, for example, at the moment when the clubhead hits the ball (i.e., the impact moment), a detected straight line as referred to the drawing number 10 is regarded as the club shaft of the golf club and the user's golf swing is analyzed.

A result of detecting a linear component on an image by the Hough Transform as described above is shown in FIG. 2.

In FIG. 2, the linear components detected on the image according to swing steps are shown as one image, and L1 to L5 shown in FIG. 2 show straight lines approximating the club shaft of the golf club from a downswing to after an impact.

These club-approximate straight lines (L1 to L5) are the result of approximating the club shaft of the golf club in a straight line, and the bending of the club shaft during the actual swing is not considered at all.

However, as shown in FIG. 1(b), during the golf swing, the golf club 11 actually has an impact by bending large or small depending on the material of the club shaft. As another example, in FIG. 1(c), it may be seen that the golf club 12 is considerably bent immediately after the impact.

As the golf club is bent during the golf swing, it will have a significant effect on the sensing results of the golf club and ball when considering and not considering the bending of the club shaft.

In contrast, referring to FIG. 3, as shown in FIGS. 3(a) to 3(c), it may be seen that the club shaft of the golf club is bent during the golf swing, which greatly affects the hit ball.

FIG. 3(a) represents the golf club GC1 of the Stiff Shaft, FIG. 3(b) represents the golf club GC2 of the Medium Shaft, and FIG. 3(c) represents the golf club GC3 of the Flexible Shaft. When each clubhead ch1, ch2, and ch3 hits the ball b1, b2, and b3, various important parameters, such as dynamic lie angles and dynamic loft angles, are greatly affected by the degree of bending of the club shaft and show a significant difference in the movement characteristics of the hit golf ball.

Since there is a limit to detecting a golf club during a golf swing from a captured image, a club approximation line was detected for the golf club and the movement of the golf club was analyzed using the club approximation line. However, when golf swings are actually performed, golf clubs are bent large or small depending on the material of the club shaft as shown in FIG. 3, so there is a problem that the movement characteristics of the golf clubs using the club approximation line are inevitably different from the actual movement of the golf clubs.

### PRIOR ART DOCUMENTS

Patent Application No. 10-2011-0025149
Patent Application No. 10-2016-0064881
Patent Application No. 10-2016-0156308

### DISCLOSURE

### Technical Problem

The present invention is to provide a method for detecting a golf club and a sensing device using the same, and provides a new method for detecting the golf club from an image captured by the sensing device. The present invention provides a method for accurately analyzing movement characteristics such as bending of a golf club by accurately detecting the shape of the golf club during golf swing by analyzing the shadow of the golf club formed on the floor in the captured image rather than directly detecting the golf club from the captured image.

### Technical Solution

In accordance with an aspect of the present invention, the above and other objects can be accomplished by the provision of a method for detecting a golf club using a sensing device including a camera, the method comprises acquiring an image at an angle of view including a golf club held by a golf swing user; calculating information on the shadow area of the golf club formed on the bottom from the image; and detecting the golf club through analysis of the information on the shadow area of the golf club.

Preferably, the calculating information on the shadow area of the golf club includes: checking pixels on the image to detect effective pixels corresponding to the shadow area, and calculating information on the shadow area of the golf club using the effective pixels.

Preferably, the calculating information on the shadow area of the golf club includes: calculating a lighting vector from the structural relationship of the camera, a light source and a bottom surface; calculating a model for a contour of the shadow of the golf club using the calculated lighting vector; and calculating information on the shadow area of the golf club by checking pixels on the image based on the model for the contour of the shadow.

Preferably, the calculating information on the shadow area of the golf club includes: detecting a club-fitted line fitted to the club shaft of the golf club by analyzing the image; calculating a model for a shadow contour of the golf club based on a straight line component projected onto the floor of the detected club-fitted line; and calculating Information on the shadow area of the golf club by checking pixels of the difference image of the acquired image based on the calculated model for the contour of the shadow so as to detect pixels corresponding to the shadow area of the golf club as effective pixels.

Preferably, the detecting the golf club includes: calculating a model for the center line of the club shaft from the information on the shadow area of the golf club; and detecting the golf club by converting the two-dimensional coordinates according to the model for the center line of the club shaft into three-dimensional coordinates.

Preferably, the detecting the golf club includes: calculating center point candidate data through fitting using Taylor series from the information on the shadow area of the golf club; calculating a model for a center line of the club shaft through fitting on the center point candidate data from which outliers are removed; and detecting the golf club by converting the two-dimensional coordinates according to the calculated model for the center line of the club shaft into three-dimensional coordinates.

Preferably, the calculating information on the shadow area of the golf club includes: detecting a shadow estimation area of the golf club from the structural relationship of the camera, a lighting source, and a bottom surface so as to calculate a model for the shadow contour from the shadow estimation area; generating a check window having a size corresponding to the model for the shadow contour so that each of the pixels is a center pixel of the check window in the detected shadow estimation area in a difference image of the acquired image; determining whether the center pixel is an effective pixel by checking all pixels inside the generated check window; calculating information on the shadow area including information on the determined effective pixels by determining the effective pixels among all pixels in the shadow estimation area.

In accordance with another aspect of the present invention, there is provided a method for detecting a golf club using a sensing device including a camera, wherein the method comprises: estimating an outline of a shadow of a golf club held by a golf swing user; detecting effective pixels corresponding to the shadow by checking pixels in the estimated outline of the shadow on the image using an image acquired by the camera in a field of view including the golf club, and calculating information on the shadow area of the golf club therefrom; and detecting the golf club through analysis of the information on the shadow area.

Preferably, the calculating information on the shadow area includes, detecting the effective pixels within the estimated outline from the difference image of the acquired image, and calculating a model for the shadow determined by the detected effective pixels, and wherein the detecting the golf club through analysis includes, calculating a model for the center line of the club shaft through the data on the image defined by the calculated model for the shadow, and detecting the golf club by converting the two-dimensional coordinates according to the model for the center line of the club shaft into three-dimensional coordinates.

In accordance with another aspect of the present invention, there is provided a method for detecting a golf club using a sensing device including a camera, wherein the method comprises acquiring an image at an angle of view including a golf club held by a golf swing user; detecting a club-fitted line approximated to a club shaft of the golf club by analyzing the image; calculating information on a shadow area of the golf club including information on pixels corresponding to the shadow area of the golf club formed on a bottom surface from the image based on a straight line component projected onto the bottom surface of the detected club-fitted line; and detecting the golf club through analysis of information on the shadow area.

In accordance with another aspect of the present invention, there is provided a sensing device for detecting a golf club during a golf swing, comprises a camera that acquires an image at an angle of view including the golf club held by a golf swing user; and a sensing processor that specifies a shadow area of the golf club formed on a bottom surface from the image and detecting the golf club through analysis of information on the specified shadow area of the golf club.

Preferably, the sensing processor is configured to: estimate an outline of the shadow of the golf club, specify a shadow area of the golf club by checking pixels in the estimated outline of the shadow from the image so as to detect effective pixels corresponding to the shadow area, calculate a model for a center line of a club shaft of the golf club from data corresponding to the specified shadow area of the golf club, and detect the golf club by converting the two-dimensional coordinates according to the model for the center line of the club shaft into three-dimensional coordinates.

### Advantageous Effects

The golf club detection method and sensing device using the same according to this invention have the effect of accurately detecting the shape of the golf club during golf swing and accurately analyzing movement characteristics such as bending of the golf club by analyzing the shadow of the golf club formed on the floor in an image captured by the sensing device.

### DESCRIPTION OF DRAWINGS

FIG. 1 illustrates (a) showing a line fitted to a golf club during a user's golf swing according to a prior art, and (b) and (c) showing that bending of the golf club occurs during a golf swing.

FIG. 2 shows an example of calculating straight lines fitted to golf club during a golf swing according to a prior art.

FIG. 3 illustrates (a) to (c) showing that the club shaft of the golf club greatly affects to hit a ball according to the degree of bending during the golf swing.

FIG. 4 shows a configuration of the sensing device according to an embodiment of the present invention.

FIG. 5 shows the method for detecting a golf club and a function and detection principle of the sensing device according to an embodiment of the present invention.

FIG. 6 is a flowchart showing a process of detecting a golf club according to an embodiment of the present invention.

FIG. 7 shows an example of an image captured by a camera of the sensing device according to an embodiment of the present invention.

FIGS. 8 and 9 show a process of estimating an outline of a shadow of a golf club in the method of detecting a golf club according to an embodiment of the present invention.

FIGS. 10 to 12 show a process of calculating information on a shadow area of a golf club in an image in the method of detecting a golf club according to an embodiment of the present invention.

FIGS. 13 to 15 show processes of detecting a center line of a club shaft using information on a shadow area in the method of detecting a golf club according to an embodiment of the present invention.

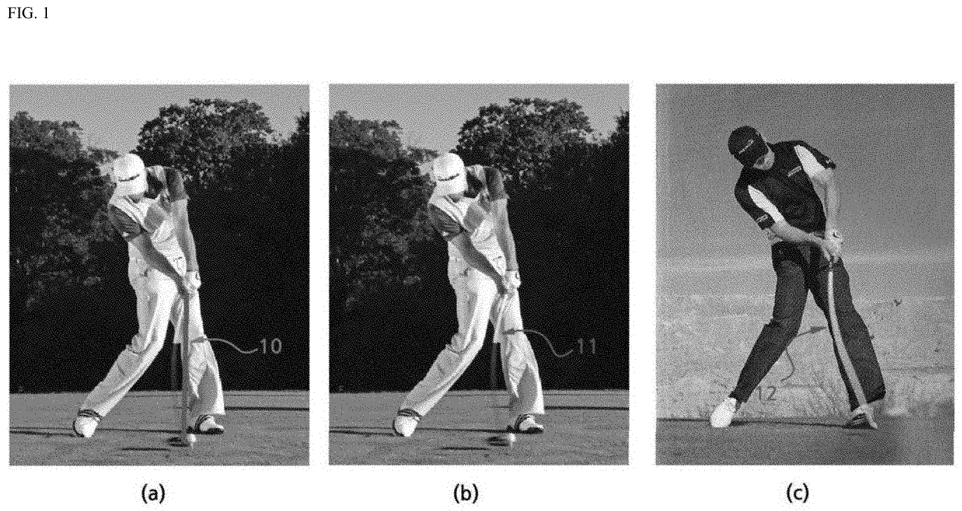

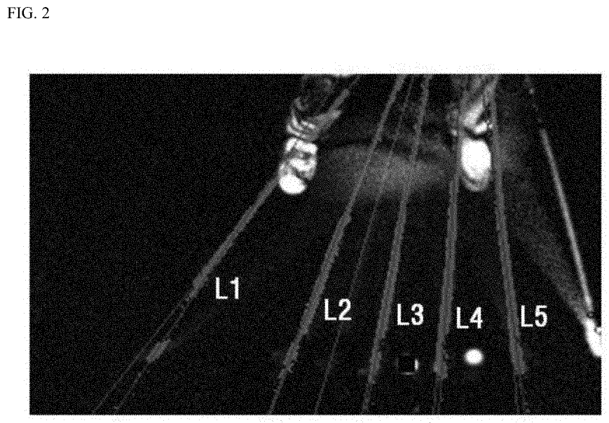

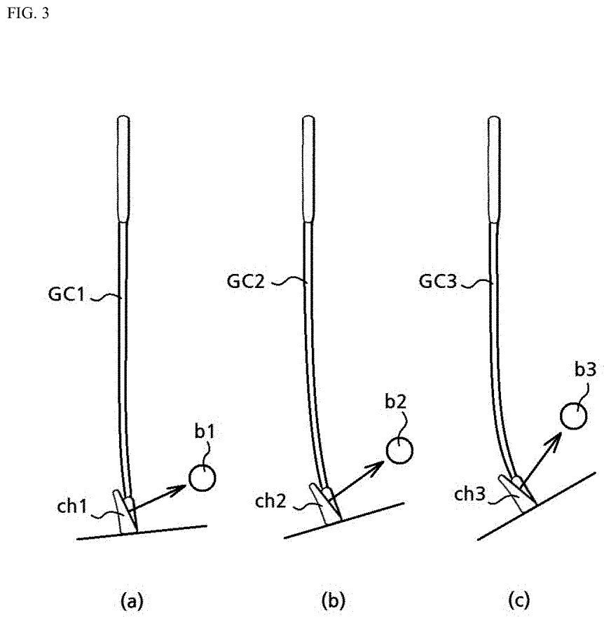

### BEST MODE

A specific description of the method for detecting a golf club and the sensing device using the same according to the present invention will be described with reference to the drawings.

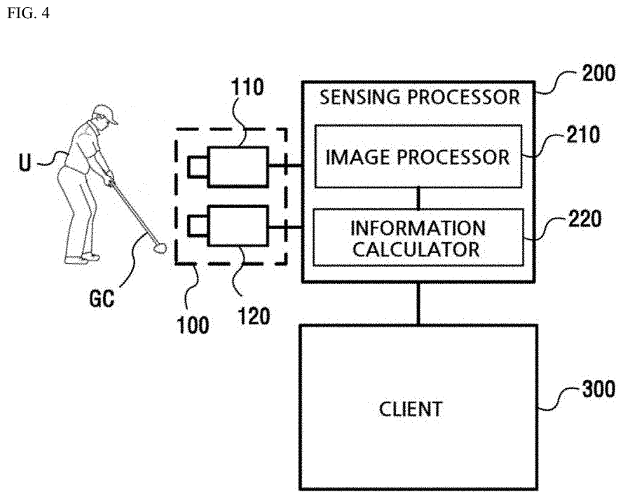

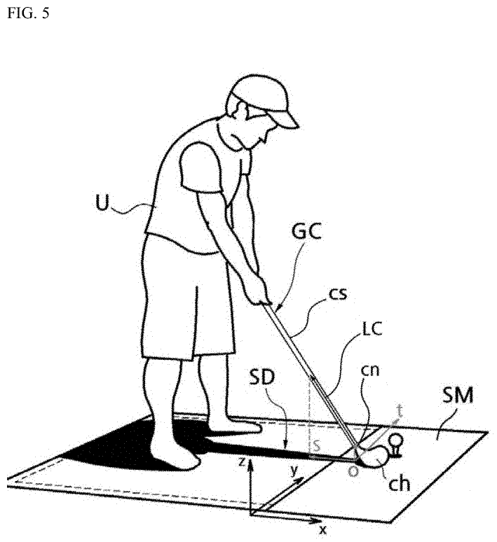

First, the configuration and function of the sensing device according to an embodiment of the present invention, and the detection principle will be described with reference to FIGS. 4 and 5. FIG. 4 shows a configuration of the sensing device according to an embodiment of the present invention, and FIG. 5 shows that a user is holding a golf club for a golf swing and taking an address posture for explaining the method for detecting a golf club and a function and detection principle of the sensing device according to an embodiment of the present invention.

The present invention relates to the method of detecting a golf club by analyzing images photographed for the moving golf club when a user swings with the golf club and hits the golf ball, and the sensing device using the method.

No matter how high-performance cameras are used to photograph, it is very difficult or impossible to accurately specify and extract the golf club from the captured image This is because even if pixels corresponding to the golf club are extracted from the captured image, the accuracy of extraction is very poor.

An object of the present invention is to accurately detect the bending of the golf club according to the swing by detecting the exact shape of the golf club during the golf swing. To this end, the sensing device according to an embodiment of the present invention does not extract a golf club from a captured image, but instead extracts a shadow area of the golf club from the captured image and detects an accurate shape of the golf club through analysis of the shadow area.

In the case of the sensing device using a camera, the camera and the light source are always provided together to photograph while providing lighting toward the subject. Accordingly, constant lighting by the light source is provided to the user holding the golf club, and a certain shadow of the golf club is always formed on the floor. While it is difficult to accurately extract the shape of the golf club from the image taken for the golf club, the shadow of the golf club is always black regardless of the material, color or reflectivity of the golf club, so it is possible to accurately detect the shape of the golf club by analyzing the shadow. As described above, the present invention provides a method and apparatus for calculating coordinate information of pixels at a location where the golf club exists on the image by deriving the shape of the golf club through shadow analysis of the golf club in the image.

As shown in FIG. 4, the sensing device according to an embodiment of the present invention may include a camera device 100 and a sensing processor 200, and the sensing processor 200 may include an image processor 210 and an information calculator 220.

The camera device 100 may be configured to consecutively acquire images with a field of view including a moving object (golf club and a golf ball). In order to calculate position information on a 3D space for a moving object, it is preferable that a plurality of the cameras (e.g., the first camera 110 and the second camera 120) acquiring images respectively for the same object at different viewing angles are synchronized with each other in a stereoscopic manner.

As described above, a plurality of cameras 110 and 120 of the camera unit 100 are synchronized with each other and configured in a stereoscopic manner, so that 2D information of the object extracted from each of the images acquired through the first camera 110 and the second camera 120 may be converted into 3D information.

In addition, any one of the first camera 110 and the second camera 120 of the sensing device according to an embodiment of the present invention may be configured to acquire an image in a field of view including a golf club held by a golf swing user to analyze a shadow of the golf club.

In order to calculate physical characteristics according to the movement of the golf ball that is hit and moved by the golf club, coordinate information in the three-dimensional space of the golf ball must be obtained. To this end, it is necessary to simultaneously drive the first camera and the second camera to photograph a subject in a stereoscopic manner and analyze the captured image. However, shadow analysis of the golf club may be performed through analysis of an image photographed by one specified among the first camera and the second camera.

Meanwhile, in FIG. 4, the sensing processor 200 may include an image processor 210 that collects images from each of the cameras 110 and 120 of the camera device 100 and extracts a specific object by performing predetermined image processing, and an information calculator 220 that calculates 3D position information from the 2D position information of the object extracted from the image.

The sensing processor 200 may extract a moving object from each of the images collected through the cameras 110 and 120 of the camera device 100, calculate location information of the extracted object, and transmit the same to the client 300. The client 300 may perform a predetermined function of the client 300, such as calculating new information or calculating predetermined analysis information using the transmitted location information of the extracted object.

For example, when the client 300 is embodied as a simulator used in a screen golf system, the simulator may receive location information of the golf ball and the golf club from the sensing processor 200 of the sensing device and implement a simulation image in which the ball flies on a virtual golf course.

For example, when the client 300 is embodied as a golf swing analysis device, the analysis device may receive position information of the golf ball and the golf club from the sensing processor 200 of the sensing device and use the same to provide analysis information, swing problem diagnosis, and lesson information to solve the same.

The image processor 210 may generate a difference image by performing a difference operation on each of the images consecutively acquired by the camera device 100 on a reference image. Pixels corresponding to a golf club part, a golf ball part, a part of shadow of the golf club, a part of a user's body, etc. may remain in the difference image.

As described above, the data on the pixels remaining in the difference image is analyzed by the information calculator 220, and through the analysis, the information calculator 220 calculates parameters such as speed, direction, height angle, spin, etc. of a golf ball, and calculates analysis information on the movement of the golf club.

In particular, the information calculator 220 may perform a process according to the method of detecting a golf club according to an embodiment of the present invention to quite accurately extract the shape of the golf club from the image.

As shown in FIG. 4, the information calculator 220 may be configured to be included in the sensing device, but is not limited thereto and may be configured to be included in the client 300. That is, the sensing device may perform a function of extracting a moving object through image acquisition and image processing, and transmit the extracted information to the information calculator of the client so as to calculate the location information of the moving object and various information using it.

In order to more effectively utilize the method of detecting a golf club according to an embodiment of the present invention, the sensing processor 200 may calculate some information in advance before analyzing the shadow.

For example, a straight line fitted to the golf club disclosed in Patent Application No. 10-2016-0156308 filed by the applicant may be obtained by a method such as the Hough Transformation. In addition, position coordinate information of the neck portion of the golf club (which may be the same position as the position of the hosel) corresponding to the boundary between the club shaft and the clubhead may be obtained. (The detection of the straight line fitted to the golf club and the detection of the position coordinates of the neck portion may be calculated in various ways, not necessarily only according to the method disclosed in Patent Application No. 10-2016-0156308).

As shown in FIG. 5, since the user U holds the golf club GC for golf swing, and the lighting device faces the user together with the camera (not shown), shadows SD are generated below and behind the golf club GC. In FIG. 5, the reference SM represents a golf mat.

As long as the camera-type sensing device acquires an image, lighting for image acquisition is provided, so that a shadow SD as shown in FIG. 5 is always generated almost constantly.

This shadow SD quite accurately reflects the shape of the golf club GC, particularly the club shaft cs. Accordingly, instead of directly extracting the golf club from the image, the shadow SD of the golf club is extracted and analyzed from the image, thereby calculating the coordinates of the golf club and obtaining information on the shape of the golf club on the image quite accurately. The present invention relates to such a method and a sensing device using the same.

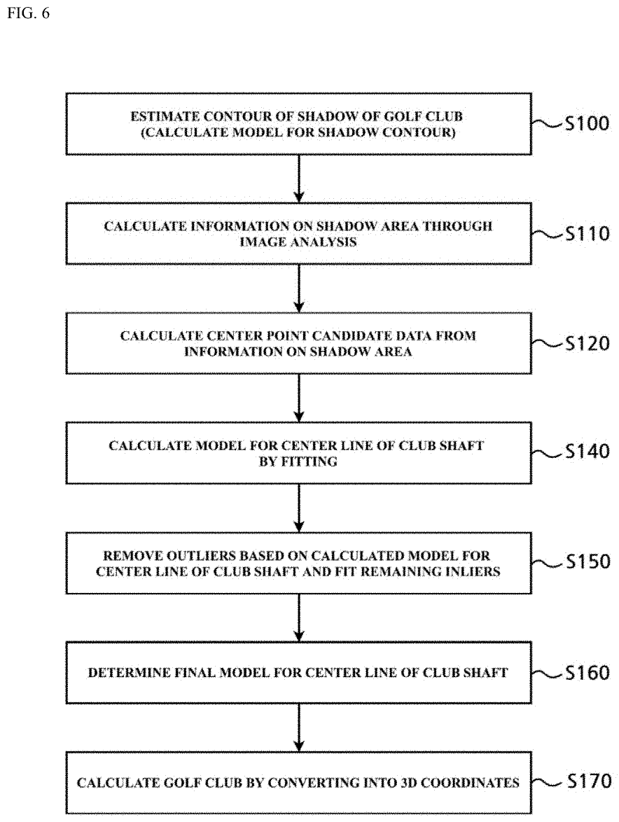

The golf club detection method of the sensing device according to an embodiment of the present invention will be described with reference to the flowchart shown in FIG. 6.

A golf club detection method according to an embodiment of the present invention includes acquiring an image with an angle of view including the golf club held by the golf swing user, calculating information on the shadow area by analyzing the shadow area of the golf club from the acquired image or an image processed by a predetermined processing (image processing such as a difference image), and detecting the golf club through analysis of the calculated information.

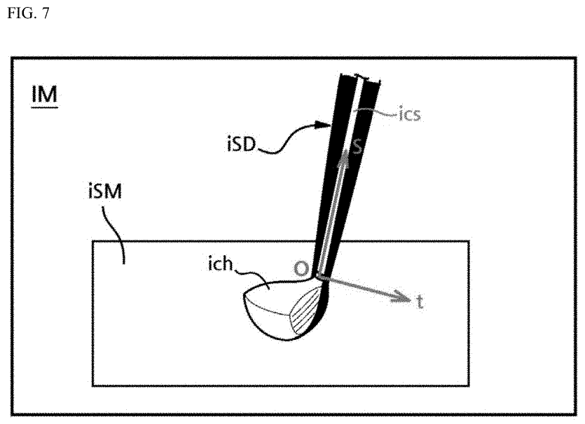

An example of an image IM acquired by the camera of the sensing device according to an embodiment of the present invention is shown in FIG. 7. As shown in FIG. 7, the camera acquisition image (IM) shows a part (ics) corresponding to the club shaft of the golf club, a part (ich) corresponding to the club head, a part (iSD) corresponding to the shadow, and a part (iSM) corresponding to the golf mat.

However, from the human eye, it is easy to recognize which part of the club shaft (ics) and the part of the shadow (iSD) on the image (IM), but from the perspective of a computing device (i.e., sensing processing unit) that specifies and recognizes objects through image analysis, it is not known which part is the club shaft and which part is the shadow.

Accordingly, in order to effectively specify and analyze a part corresponding to the shadow of the golf club, it may be necessary to estimate the shadow contour of the golf club in step S100 of FIG. 6, that is, the shadow contour of the golf club may be estimated by calculating a model for the shadow contour.

The sensing device according to an embodiment of the present invention may be configured to sense the movement of the hit golf ball when the golf ball is hit. In order to calculate the position coordinates of the golf ball, as shown in FIG. 5, a space in which the golf swing is performed may be defined as a three-dimensional coordinate system of x-y-z.

However, If the part corresponding to the shadow of the golf club is defined and calculated by the x-y-z coordinate system described above, the computing calculation may become complicated and difficult. Accordingly, it is preferable to define another coordinate system to make shadow analysis easier and more effective, and to convert coordinate information according to the final model calculated from the coordinate system into three-dimensional coordinates of the x-y-z coordinate system.

Regarding the definition of another coordinate system, FIGS. 5 and 7 show an s-t coordinate system set for shadow analysis.

Since the shadow SD of the golf club is formed under the golf club, it is preferable to set a new coordinate system, the s-t coordinate system, based on the golf club. As shown in FIG. 5, the origin (st origin) of the s-t coordinate system may be set as the point (O) at which the neck position is projected onto the floor surface along the camera gaze, wherein the neck position is a position corresponding to a boundary between the club shaft cs and the club head ch of the golf club GC (e.g., a position of a hozel).

And, as shown in FIG. 5, a club-fitted line (LC) where the club shaft (cs) of the golf club (GC) is fitted in a straight line is obtained. The point S projected onto the floor surface along the camera gaze is obtained from the point on the club-fitted line (LC). The direction from the st origin O to the point S may be set in the s-axis direction. The t-axis may be set in a direction orthogonal to the s-axis.

Here, the neck portion, which is the reference for calculating the st origin, and the club-fitted line, which is the basis for the s-axis direction, may be detected by various methods. For example, according to the method disclosed in Patent Application No. 10-2016-0156308 filed by the present applicant, it is possible to detect the club-fitted line and neck part through image analysis.

As described above, the st origin and the s-axis of the s-t coordinate system may be determined based on the position of the neck part and the club-fitted line, but the present invention is not limited thereto and may be determined by another reference.

In addition, since the above-described setting of the s-t coordinate system is for effective shadow analysis, it is of course possible to use the existing x-y-z coordinate system as it is.

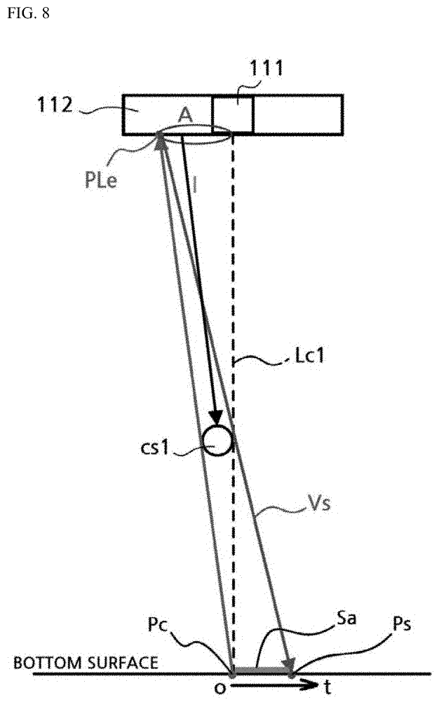

As shown in FIG. 6, the step S100 of estimating the outline of the shadow of the golf club may be based on the s-t coordinate system defined as described above, and an example of the method is shown in FIG. 8.

FIG. 8 shows a principle of estimating an outline of the shadow of the golf club by the method of detecting the golf club according to an embodiment of the present invention. For example, when the sensing device is installed above the user's head in the state shown in FIG. 5, a plane parallel to the yz plane may be shown in FIG. 8.

In FIG. 8, a portion indicated by the drawing number cs1 represents a cross section in which the club shaft is cut by a plane. The drawing number 111 indicates a camera and the drawing number 112 indicates a lighting source, wherein the sensing device include the camera and the lighting source and installed above the user's head (or including a front side of the user standing at-bat).

Here, the sensing device according to an embodiment of the present invention includes a stereoscopic first camera 110 and a second camera 120 as shown in FIG. 4, and the shadow analysis may be performed by either of the two cameras.

In order to estimate the outline of the shadow of the golf club, the detection result of the club-fitted line and the neck part of the golf club for setting the s-t coordinate system may be used, and information on the position of the camera 111 & the lighting source 112 and the bottom surface may be measured in advance and used as a set value.

That is, it is preferable that information on the distance between the camera 111 and the bottom surface and distance between the lighting source 112 and the bottom surface in FIG. 8 is preset as a default value.

As shown in FIG. 8, the light provided from the lighting source 112 is covered by the golf club (cross part cs1 of the club shaft) to form a shadow around the club shaft on the bottom surface. In this case, the area estimated to be the shadow of the golf club will be referred to as the shadow estimation area Sa.

In the state shown in FIG. 8, a lighting vector may be obtained from a structural relationship such as the camera, the lighting source, and the bottom surface. That is, the lighting vector Vs from the end of the lighting to the outline of the shadow estimation area Sa may be obtained.

In order to obtain the lighting vector Vs, a point where the gaze Lc1 of the camera 111 located at the center of the lighting source 112 passes through one aspect of the outline of the club shaft cs1 and reaches the bottom surface is referred to as Pc, and a point where the club shaft 112 passes through the other aspect of the outline of the club shaft cs1 and reaches the lighting source 112 is referred to as PLe.

The PLe point is a point corresponding to the end of the lighting that affects shadow formation. On the camera 111 and the lighting source 112, the lighting provided in the area (A region) between the PLe point and the center is blocked by the club shaft cs1 to form the right portion of the shadow on the bottom surface. The left portion of the shadow is made by the lighting portion of the right symmetrical position in the A region. (forming the right portion of the shadow is shown In FIG. 8, and the left portion of the shadow may be obtained as symmetry of the right portion).

In FIG. 8, a Ps point, which is a point from the PLe point of the lighting to the bottom surface past the right contour of the club shaft cs1, corresponds to the position on the outline position of the shadow estimation area Sa. That is, the section between the Pc point and the Ps point becomes the shadow estimation area Sa.

In the s-t coordinate system, the t coordinate of the Ps point corresponds to the length to one outline of the shadow estimation area.

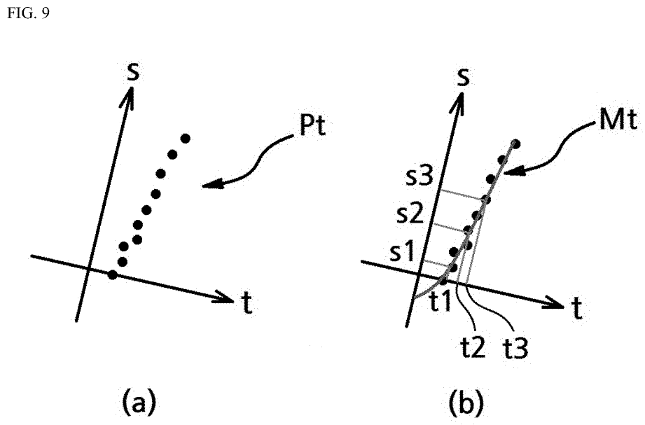

By obtaining Ps for the whole yz plane along the club shaft in the above manner, as shown in FIG. 9(a), a set Pt of data for Ps calculated in the s-t coordinate system can be obtained.

The set Pt of data for Ps on the s-t coordinate system as shown in FIG. 9(a) corresponds to coordinate data of points corresponding to the outline of the shadow estimation area Sa.

A model for the shadow contour may be calculated from coordinate data of points corresponding to the outline of the shadow area, and a fitting (e.g., polynomic fitting) may be performed using the model for the shadow contour as an n-th polynomial. Here n is a natural number of 2 or more. As n increases, the higher-order polynomial of the model to be fitted can increase the accuracy of the shadow contour, while it can be a burden on the computer's computation, so the shadow contour can preferably be modeled in a tertiary polynomial.

FIG. 9(b) shows a model calculated by fitting an n-th polynomial to a set Pt of data for Ps calculated in the s-t coordinate system as described above, that is, a model Mt for the shadow contour.

When information on one side portion of the shadow estimation area is obtained based on the s-axis as described above, information on the opposite side portion of the shadow estimation area symmetrical with respect to the s-axis may also be obtained. The entire shadow estimation area may be extracted from the image through the obtained information, and the actual shadow area may be determined by examining pixels of the extracted area.

As shown in FIG. 6, the sensing processor of the sensing device according to an embodiment of the present invention performs a step of estimating the outline of a shadow of the golf club in step S100, and then calculates information on the shadow area through image analysis in step S110.

Before the calculation of ‘information on the shadow area’ in step S110 is described, the definition of the term ‘shadow area’ will be described first.

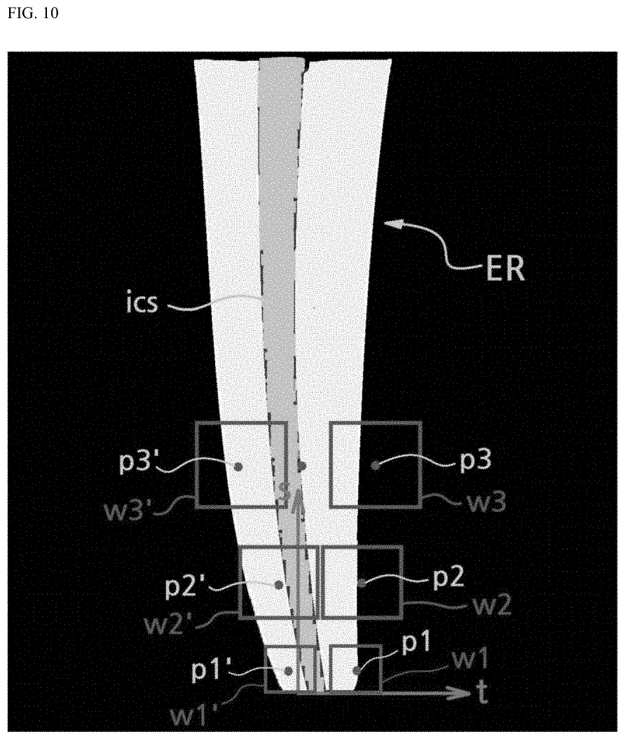

When a difference image from a preset reference image is extracted from the image IM acquired by the camera shown in FIG. 7, then, a portion corresponding to the shadow estimation area as described above is extracted from the difference image, Image information as shown in FIG. 10 may be obtained.

FIG. 10 shows a case in which a portion ‘ics’ corresponding to the club shaft of the golf club is bent. (FIG. 10 shows a portion ‘ics’ corresponding to the club shaft to aid understanding, and the sensing processor cannot recognize which part corresponds to the club shaft).

Since the sensing device according to the present invention acquires an image by viewing a user holding a golf club and swinging, as shown in FIG. 7, the golf club may acquire an image while covering a shadow. It is difficult to separately extract only the part corresponding to the shadow of the golf club from the acquired image. Accordingly, the sensing device according to an embodiment of the present invention may extract and analyze the area of the shadow with the golf club part rather than separately extracting only the part corresponding to the shadow from the acquired image.

That is, the ‘shadow area’ may be an area that includes not only the shadow itself but also the part corresponding to the golf club covering the shadow on the acquired image as shown in FIG. 7.

Extracting a portion corresponding to the shadow estimation area described above will be referred to ‘ER’ as shown in FIG. 10.

A portion corresponding to the shadow estimation area may be extracted from the difference image. When the difference image between the image acquired by the camera and the reference image is obtained, parts having the same pixel value in the two images are removed in the difference image, and parts having different pixel values in the two images remain in the difference image. For example, as shown in FIG. 10, each of the pixels of the remaining part by the difference has a predetermined pixel value (i.e., a brightness value), and the part removed by the difference appears black because the pixel value is zero by the difference.

Since the ‘shadow area’ is the area on the image including both the shadow and the golf club part, and the ‘shadow area’ exists in the extracted area ER as the shadow estimation area as described above, it is necessary to analyze all pixels in the shadow estimation area ER to determine pixels corresponding to the shadow area (referred to as “effective pixels”) as shown in FIG. 10.

An example of the step S110 of calculating information on a shadow area through image analysis on the flowchart of FIG. 6 will be described in more detail with reference to FIGS. 9 and 10.

An example of obtaining a lighting vector from a structural relationship with respect to a location of a camera, lighting, floor, golf club, etc., described with reference to FIG. 8, and using the lighting vector to obtain an outline of the shadow estimation area, i.e., a model for the shadow contour, is shown in FIG. 9(b).

The fitted curve shown in FIG. 9(b) is the model (Mt) for the shadow contour, and all points on the model (Mt) have coordinate values of the s-axis and the t-axis.

For example, as shown in FIG. 9(b), a point (referred to as p1) having values [s1, t1], a point (referred to as p2) having values [s2, t2], and a point (referred to as p3) having values [s3, t3] will be described.

The point of p1, p2, and p3 in the shadow estimation area ER extracted from the difference image of FIG. 10 have [s1, t1], [s2, t2], and [s3, t3], respectively, as shown in FIG. 9(b).

Here, the values of t1, t2, and t3 are values corresponding to the radius of the shadow estimation area, respectively, and a check window is generated based on the size thereof.

That is, for all pixels in the extracted area as the shadow estimation area of FIG. 10, a check window may be generated based on the size of a radius around each pixel. When the pixels inside the check window meet a preset requirement, the center pixel of the check window is determined as an effective pixel.

The requirement for determining the effective pixel may be preset, for example, when the number of pixels having a pixel value equal to or greater than a predetermined value for each of the pixels inside the check window is equal to or greater than a predetermined ratio (e.g., 50%) of the total.

When setting a check window centered on a specific pixel, the size of the check window corresponds to the radius of the shadow estimation area, and if the number of pixels having a pixel value equal to or greater than a predetermined value exceeds half of all pixels in the check window, it may be determined that the center pixel of the check window is in the shadow area.

If less than half of the pixels inside the check window have a pixel value equal to or greater than a predetermined value, it may be determined that the center pixel is a pixel outside the shadow area.

In FIG. 10, pixels of p1, p2, p3 and p1′, p2′, and p3′ will be described as examples. (Here, six pixels are described as examples, but all pixels may be checked in the same manner).

Here, p1, p2, and p3 are pixels near the outline of the shadow estimation area, p1′ (having the same s coordinate as p1), p2′ (having the same s coordinate as p2), and p3′ (having the same s coordinate as p3) are pixels in the shadow area, respectively. (p1′, p2′, p3′ are in the shadow area as shown in FIG. 10, but it is not known whether they are in the shadow area before checking the effective pixel using the check window).

In addition, the shadow estimation area and the shadow area may not match each other. The shadow estimation area is estimated by geometric analysis using a lighting vector, and since the part corresponding to the actual shadow is the shadow area, in most cases, the two do not match each other.

What will be described with reference to FIG. 10 is to determine which pixel is an effective pixel corresponding to the shadow area by applying a check window corresponding to the radius size of the shadow estimation area to every pixel in the shadow estimation area.

As shown in FIG. 10, p1 and p1′ have the same value of s1 as the s-axis coordinate value, a check window w1 having horizontal and vertical sizes of t1 value (the t-coordinate value corresponding to the s1 value in the model for the shadow contour) corresponding to the radius of the shadow estimation area is generated centered on the p1 pixel, and pixels inside the check window w1 are checked. In addition, the w1′ check window (the same size as the check window w1) may be generated centered on the p1′ pixel to check the pixels therein.

Since the number of pixels having a pixel value of a predetermined value is less than half inside the w1 check window, it may be determined that the p1 pixel, which is the center pixel of the w1 check window, is not an effective pixel. Inside the w1′ check window, since the number of pixels having a pixel value of a predetermined value is much more than half, the p1′ pixel, which is the center pixel of the w1′ check window, may be determined as an effective pixel.

In this way, it is possible to determine whether or not it is an effective pixel by using the check window having a size t1 for all pixels having an s1 coordinate value.

And in this way, each of the pixels having coordinate values of all the s-axis may be determined by determining whether an effective pixel is valid using the check window in the same manner as described above.

In this case, the size of the check window is preferably based on the coordinate value of the t-axis corresponding to the coordinate value of the s-axis in the model for the shadow contour shown in FIG. 9(b).

Accordingly, the shadow area can be effectively specified. If it is determined whether or not all pixels are effective using the same check window, the shadow area becomes an area with the same (vertical line) outline in the coordinate values of the t-axis coordinate values. Accordingly, varying the size of the check window for each pixel based on the previously obtained shadow contour model is one of the important parts in the extraction of the shadow area.

Similar to previously determining whether p1 and p1′ pixels are effective pixels using check windows w1 and w1′, it is possible to check whether p2 and p2′ pixels shown in FIG. 10 are effective pixels.

As shown in FIG. 10, p2 and p2′ have the same value of s2 as the s-axis coordinate value, a check window w2 having horizontal and vertical sizes of t2 value (the t-coordinate value corresponding to the s2 value in the model for the shadow contour) corresponding to the radius of the shadow estimation area is generated centered on the p2 pixel, and pixels inside the check window w2 are checked. In addition, the w2′ check window (the same size as the check window w2) may be generated centered on the p2′ pixel to check the pixels therein.

Since the number of pixels having a pixel value of a predetermined value is less than half inside the w2 check window, it may be determined that the p2 pixel, which is the center pixel of the w2 check window, is not an effective pixel. Inside the w2′ check window, since the number of pixels having a pixel value of a predetermined value is much more than half, the p2′ pixel, which is the center pixel of the w2′ check window, may be determined as an effective pixel.

In this way, it is possible to determine whether or not it is an effective pixel by using the check window having a size t2 for all pixels having an s2 coordinate value.

And, as shown in FIG. 10, p3 and p3′ have the same value of s3 as the s-axis coordinate value, a check window w3 having horizontal and vertical sizes of t3 value (the t-coordinate value corresponding to the s3 value in the model for the shadow contour) corresponding to the radius of the shadow estimation area is generated centered on the p3 pixel, and pixels inside the check window w3 are checked. In addition, the w3′ check window (the same size as the check window w3) may be generated centered on the p3′ pixel to check the pixels therein.

Since the number of pixels having a pixel value of a predetermined value is less than half inside the w3 check window, it may be determined that the p3 pixel, which is the center pixel of the w3 check window, is not an effective pixel. Inside the w3′ check window, since the number of pixels having a pixel value of a predetermined value is much more than half, the p3′ pixel, which is the center pixel of the w3′ check window, may be determined as an effective pixel.

In this way, it is possible to determine whether or not it is an effective pixel by using the check window having a size t3 for all pixels having an s3 coordinate value.

The shadow area may be finally specified by determining the effective pixels by checking whether all pixels in the shadow estimation area are effective pixels in the above-described manner.

When a shadow area including effective pixels is specified as described above, pixel value of each of the pixels constituting the shadow area is not important and may be treated as the same shadow.

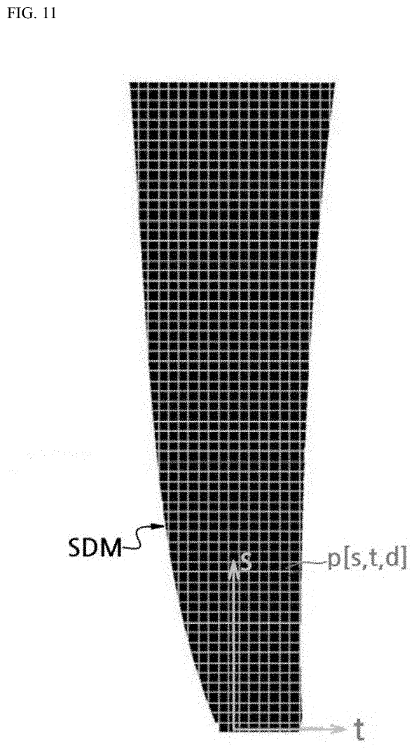

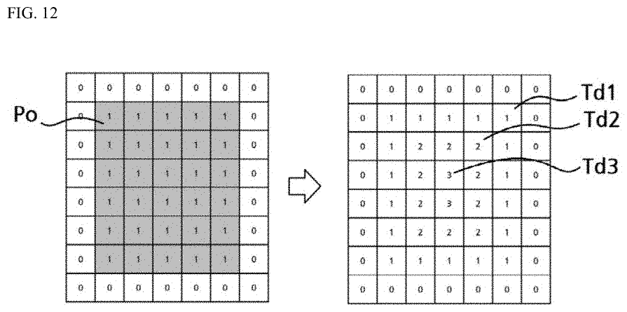

After extracting the shadow area as described above, Distance Transform, that is, all pixels corresponding to the shadow area may be converted to have a value for a geometric distance. This will be described in more detail with reference to FIGS. 11 and 12.

FIG. 11 shows a shadow information map obtained by performing distance transform on pixels (i.e., pixels in the shadow area) determined as effective pixels through checking of effective pixels using the check window in FIG. 10. The shadow information map will be referred to as “information on a shadow area” referred to in step S110 of FIG. 6. All pixels of the information on the shadow area SDM shown in FIG. 11 have s value and t value of the s-t coordinate system and a distance value d. Here, the distance value d is a value that each pixel has by the above-described Distance Transform, which will be described with reference to FIG. 12.

Assuming that pixels Po having a pixel value of 1 exist in the left image of FIG. 12, when converted into Distance Transform, the pixels Td3 located geometrically at the center of the right image of FIG. 12 have the highest distance value. The closer the distance is geometrically from the pixels having the highest distance value, the higher the distance value is, and the farther the distance is, the lower the distance value is.

For example, in the right image of FIG. 12, the central pixels Td3 may have a value of 3, the pixels of Td2 may be converted to have a value of 2, and the pixels of Td1 may be converted to have a value of 1.

When the above-described Distance Transform is performed on all pixels in the shadow area by the effective pixels detected using the above-described check window, all pixels in the shadow area may be converted to have a higher distance value as they are geometrically closer to the center.

Accordingly, the information on the shadow area SDM shown in FIG. 11 is that all pixels have the distance value d by the Distance Transform described above. That is, all pixels have values of [s, t, d].

Here, if the distance value d is a result value of Distance Transform, and a value obtained by converting it into a unit suitable for the s-t coordinate system is D, all pixels on the information on the shadow area SDM have values of [s, t, D].

The shadow area as shown in FIG. 11 is based on the s-t coordinate system, and the model for the the shadow area contour may be determined through n-th polynomial fitting. For example, the result of polynomic fitting in a 3-th polynomial can be expressed as follows, which can be determined as the model for the shadow area.

R(s)=As³+Bs²+Cs+E [Equation 1]

Here, R(s) is a model representing a distance from the center of the shadow area to the contour.

For the [s, t, D] data calculated by the above Distance Transform, when the distance D to the contour has the maximum value among all data (i.e., [s1, t, D] data) with s=s1, the maximum value D becomes R(s1).

That is, R(s) becomes a model representing the maximum value D for all s. R(s) is a model that represents the size of the shadow area for all s (the size of the shadow area may be represented by a radius or a size or a distance to the contour).

Here, A, B, C, and E are all constants and values determined by fitting.

Referring back to FIG. 6, when information on the shadow area in step S110 is calculated in the above manner, a step of calculating center point candidate data from the information on the shadow area may be performed in step S120.

Since a line passing through the center, that is, a center line, becomes a center line of the club shaft of the golf club in the shadow area as shown in FIG. 11, it is necessary to obtain the center line, and a center point candidate is first obtained for obtaining the center line.

The detected object including the shadow, for example, as shown in FIG. 7, the thickness of the shadow becomes thicker toward the grip of the golf club. As shown in FIG. 5, since the golf club is placed obliquely with respect to the bottom surface, the shadow of the club shaft is bound to become thicker as it goes from the clubhead close to the bottom surface to the grip.

Since an error occurs when detecting the center line for the thickening shadow area, in order to obtain the centerline more accurately, it is preferable to apply an approximation function such as Taylor Series to the information on the shadow area to collect the wide and uniformly scattered data to the center with high density.

Each of the data on the shadow area as shown in FIG. 11 has a value of [s, t, D], which is denoted by D(s, t). This means that the coordinates s and t have D values.

The unknown t corresponding to the center of the club shaft is referred to as “tc”, and D(s, t) data are used to find “tc”.

For the development of an equation using D(s, t), i.e., to obtain D(s, tc) for unknown tc, D(s, tc) is approximated to Taylor series at the point D(s, t).

In FIG. 11, since the distance value D of the data located along the s-axis direction in the information on the shadow area has little change depending on the s-axis direction, the differential component for s may be treated as ‘0’. In other words, it can be expressed as follows.

$$\frac{d D}{d s} = 0$$

Accordingly, the Taylor series is developed only for the variable t as follows.

$$D ( s , t c ) = D ( s , t ) + \begin{matrix}\frac{d D}{d t} \frac{( t c - t )}{1 !} + \frac{{d}^{2} D}{d {t}^{2}} \frac{{( t c - t )}^{2}}{2 !} + \frac{{d}^{3} D}{d {t}^{3}} \frac{{( t c - t )}^{3}}{3 !} + … & [ Equation 2 ]\end{matrix}$$

Both the s-t coordinate system and the D value are the same unit, and the distance value D on the map SDM showing the information on the shadow area shown in FIG. 11 is constantly increased or decreased in the t-axis direction.

Thus,

$$\frac{d D}{d t}$$

is approximate |1| and has (+) and (−) signs depending on the increasing or decreasing direction.

Since

$$\frac{d D}{d t}$$

is a constant, the derivative for t of the second order or more is zero.

Accordingly, in the Taylor series development equation shown in Equation 2, the first derivative term for t is left and summarized as follows.

$$D ( s , t c ) = D ( s , t ) + \frac{d D}{d t} \frac{( t c - t )}{1 !} \qquad [ Equation 3 ]$$

In Equation 3,

$$\frac{d D}{d t} = 1$$

should be used to access tc when tc>t, and

$$\frac{d D}{d t} = - 1$$

when tc<t. Accordingly, the equation considering the two cases is as follows.

D(s,tc)=D(s,t)+|tc−t| [Equation 4]

The distance value D from the center tc of the shadow area to the contour of the shadow area is the same as R(s), which is the model of the shadow area shown in Equation 1 above.

Accordingly, when D(s, tc) is replaced with R(s) in Equation 4, the following Equation 5 may be obtained.

R(s)=D(s,t)+|tc−t| [Equation 5]

Equation 5 is summarized with respect to tc in order to obtain the position of tc that is the center of the shadow area using Equation 5.

|tc−t|=R(s)−D(s,t) [Equation 6]

In Equation 6, if tc>t, Equation 7 as follows is obtained.

tc=R(s)−D(s,t)+t [Equation 7]

In Equation 6, if tc<t, Equation 8 as follows is obtained.

tc=−R(s)+D(s,t)+t [Equation 8]

Since tc, which is the center point of the shadow area, is an unknown value, the magnitude relationship between tc and tin Equation 6 is unknown.

Accordingly, both tc according to Equation 7 and tc according to Equation 8 are obtained for all data D(s, t) data on the shadow area as shown in FIG. 11.

As described above, a value of tc obtained for all D(s, t) data by Equations 7 and 8 becomes center point candidate data.

Returning to FIG. 6, when center point candidate data is calculated in step S120 from the information on the shadow area as described above, the tendency of center point candidate data to be gathered around the center line (which is still unknown information) is quite clear. Accordingly, fitting is performed on the center point candidate data in step S130, and a model for the center line of the club shaft is calculated through the fitting in step S140.

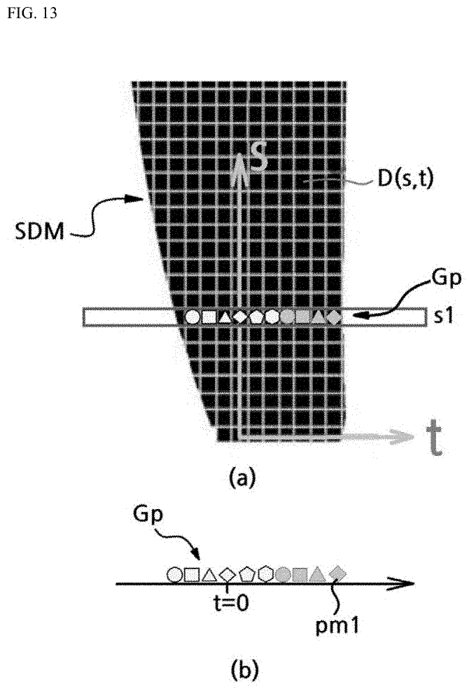

This will be described with reference to FIGS. 13 to 15.

As described above, when the center point tc is obtained by Equations 7 and 8, a pair of results occur for each D(s, t) data, wherein one of the pair of tc results approaches the center of the shadow region and the other becomes a position farther away from the center.

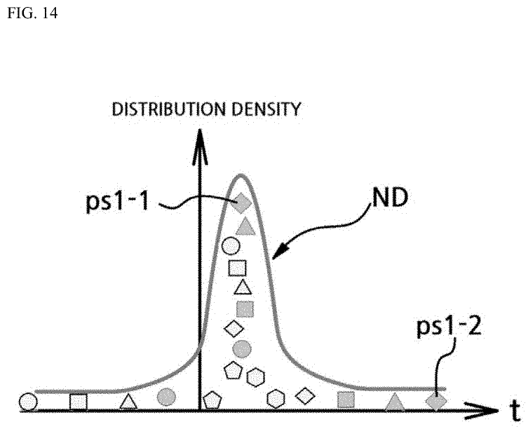

For example with reference to FIGS. 13 and 14, FIG. 13(a) is an extract of a part of FIG. 11, and shows data Gp having an s1 value which is an s coordinate value among D(s, t) data on the shadow area by various symbols (Each symbol is a point representing data, indicating that it is different data, and is represented for convenience of explanation).

When center point candidate data is obtained for these data Gp by the Taylor series of Equations 7 and 8 described above, a pair of data are generated for each data, which is shown in FIG. 14.

For example, pm1 data among the data Gp illustrated in FIG. 13(b) is represented as data of ps1-1 and ps1-2 shown in FIG. 14 by convergence by Taylor series.

As described above, a plurality of data as shown in FIG. 14 are generated by the Taylor series deployment of each of the data Gp shown in FIG. 13(b), and as shown in FIG. 14, one of the pair of data converges to the center and the other is present at a position far from the center. Accordingly, as shown in FIG. 14, a result of distributing a high density ND of data at the center is generated.

In FIGS. 13(a) and 13(b), and 14 only data having an s1 value are described as examples, and when center point candidate data is obtained by Taylor series for all D(s, t) data in this way, a significant number of data converges to the center and the remaining data are scattered around.

Accordingly, the data scattered around as described above are distinguished from the data approached around the center.

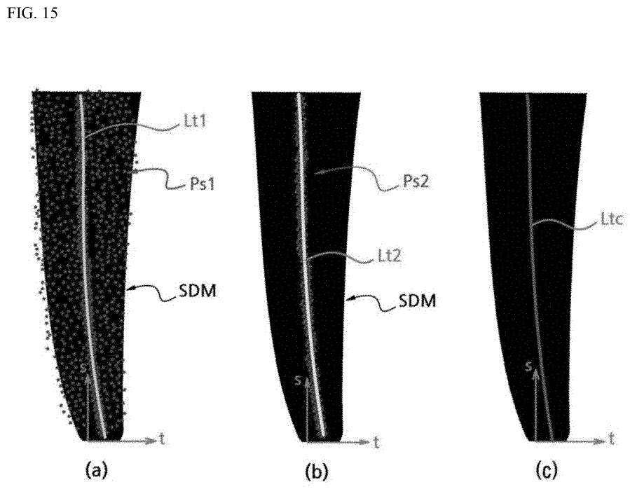

Examples of the center point candidate data obtained as described above are shown in FIG. 15(a) (the somewhat exaggerated expression in the drawing is intended to help understand the description).

In FIG. 15(a), center point candidate data Ps1 calculated by applying Taylor series in the information on the shadow area SDM is divided into data converged around the center and data scattered around the center. Accordingly, the center line Lt1 may be obtained by fitting the center point candidate data Ps1.

Through the above-described fitting, an n-th order function, such as a 3-th order function, may be obtained, which may be expressed as described above.

tc(s)=A′s³+B′s²+C′s+E′ [Equation 9]

Here, A′, B′, C′, and E′ are all constants and are values determined by the fitting.

As described above, the line of the n-th order function may be fitted through the fitting based on the data converged around the center, which can be the center line of the club shaft (S140, see FIG. 6).

Meanwhile, returning to FIG. 6, as described above, the center line of the club shaft may be obtained through fitting on the center point candidate data, and the accuracy thereof may be increased.

In order to increase the accuracy of the center line fitting, a distance of each data may be calculated based on the calculated center line model, and data exceeding a predetermined distance may be removed as an outlier.

In addition, the outlier may be removed and the remaining data may be fitted (S150) again to obtain a more accurate center line model, which may be determined as the final center line model (S160).

FIG. 15(b) shows that outliers are removed based on the center line Lt1 obtained in FIG. 15(a). For the data remaining after outliers are removed, that is, data Ps2 corresponding to the inlier, the center line model Lt2 of the 3-th order function as shown in Equation 9 may be obtained again.

The center line model Lt2 may be determined as a final center line model, or the final center line model may be calculated by removing outliers again based on the center line model Lt2 and fitting the center line around the remaining inlier data.

FIG. 15(c) shows the finally calculated center line Ltc.

When the centerline model of the clubshaft is finally determined through the above-described processes, it has a two-dimensional coordinate value of s-t coordinates, which can be converted into three-dimensional coordinates. By converting into three-dimensional coordinates as described above, a golf club in a three-dimensional space may be accurately detected in step S170.

For example, obtaining a swing plane according to a user's golf swing is a well-known technology, and when a center line model of a club shaft on the s-t plane is obtained by the method according to this invention as described above, coordinates on the center line of the club shaft may be projected onto the swing plane to obtain coordinate information on the club shaft in a three-dimensional space.

The three-dimensional coordinates of the club shaft obtained in this way can detect all the bending of the club shaft that occurs during the golf swing. Accordingly, compared with the results obtained by approximating the club shaft of the golf club in a straight line and sensing based on the method as described above, the method according to an embodiment of the present invention has an advantageous effect compared to the prior art because it can produce accurate results closest to the actual golf swing result.

Since the present invention may detect all bending of the club shaft of the golf club as described above, a kick point, which is a point at which the club shaft bends during a golf swing, may be measured, and the present invention has the advantage of being able to accurately measure swing properties such as loft angle and club trajectory, especially, swing properties that had no choice but to be estimated because it was difficult to detect according to the prior art.

### INDUSTRIAL APPLICABILITY

The method for detecting a golf club according to the present invention and the sensing device using the same may be used in a technical field related to golf analysis or a virtual golf simulation system based on an analysis of the movement of the golf club during a golf swing.

1. A method for detecting a golf club using a sensing device including a camera, the method comprising:
acquiring an image at an angle of view including a golf club held by a golf swing user;
calculating information on the shadow area of the golf club formed on the bottom from the image; and
detecting the golf club through analysis of the information on the shadow area of the golf club.

2. The method according to claim 1, wherein the calculating information on the shadow area of the golf club includes:
checking pixels on the image to detect effective pixels corresponding to the shadow area, and calculating information on the shadow area of the golf club using the effective pixels.

3. The method according to claim 1, wherein the calculating information on the shadow area of the golf club includes:
calculating a lighting vector from the structural relationship of the camera, a light source and a bottom surface;
calculating a model for a contour of the shadow of the golf club using the calculated lighting vector; and
calculating information on the shadow area of the golf club by checking pixels on the image based on the model for the contour of the shadow.

4. The method according to claim 1, wherein the calculating information on the shadow area of the golf club includes:
detecting a club-fitted line fitted to the club shaft of the golf club by analyzing the image;
calculating a model for a shadow contour of the golf club based on a straight line component projected onto the floor of the detected club-fitted line; and
calculating Information on the shadow area of the golf club by checking pixels of the difference image of the acquired image based on the calculated model for the contour of the shadow so as to detect pixels corresponding to the shadow area of the golf club as effective pixels.

5. The method according to claim 1, wherein the detecting the golf club includes:
calculating a model for the center line of the club shaft from the information on the shadow area of the golf club; and
detecting the golf club by converting the two-dimensional coordinates according to the model for the center line of the club shaft into three-dimensional coordinates.

6. The method according to claim 1, wherein the detecting the golf club includes:
calculating center point candidate data through fitting using Taylor series from the information on the shadow area of the golf club;
calculating a model for a center line of the club shaft through fitting on the center point candidate data from which outliers are removed; and
detecting the golf club by converting the two-dimensional coordinates according to the calculated model for the center line of the club shaft into three-dimensional coordinates.

7. The method according to claim 1, wherein the calculating information on the shadow area of the golf club includes:
detecting a shadow estimation area of the golf club from the structural relationship of the camera, a lighting source, and a bottom surface so as to calculate a model for the shadow contour from the shadow estimation area;
generating a check window having a size corresponding to the model for the shadow contour so that each of the pixels is a center pixel of the check window in the detected shadow estimation area in a difference image of the acquired image;
determining whether the center pixel is an effective pixel by checking all pixels inside the generated check window; and
calculating information on the shadow area including information on the determined effective pixels by determining the effective pixels among all pixels in the shadow estimation area.

8. A method for detecting a golf club using a sensing device including a camera, the method comprising:
estimating an outline of a shadow of a golf club held by a golf swing user;
detecting effective pixels corresponding to the shadow by checking pixels in the estimated outline of the shadow on the image using an image acquired by the camera in a field of view including the golf club, and calculating information on the shadow area of the golf club therefrom; and
detecting the golf club through analysis of the information on the shadow area.

9. The method according to claim 8, wherein the calculating information on the shadow area includes,
detecting the effective pixels within the estimated outline from the difference image of the acquired image, and calculating a model for the shadow determined by the detected effective pixels, and
wherein the detecting the golf club through analysis includes,
calculating a model for the center line of the club shaft through the data on the image defined by the calculated model for the shadow, and detecting the golf club by converting the two-dimensional coordinates according to the model for the center line of the club shaft into three-dimensional coordinates.

10. The method according to claim 8, wherein the calculating information on the shadow area includes,
detecting a club-fitted line approximated to a club shaft of the golf club by analyzing the image; and
calculating information on the shadow area of the golf club including information on pixels corresponding to the shadow area of the golf club formed on a bottom surface from the image based on a straight line component projected onto the bottom surface of the detected club-fitted line; and
detecting the golf club through analysis of information on the shadow area.

11. A sensing device for detecting a golf club during a golf swing, comprising:
a camera that acquires an image at an angle of view including the golf club held by a golf swing user; and
a sensing processor that specifies a shadow area of the golf club formed on a bottom surface from the image and detecting the golf club through analysis of information on the specified shadow area of the golf club.

12. The sensing device according to claim 11, wherein the sensing processor is configured to:
estimate an outline of the shadow of the golf club,
specify a shadow area of the golf club by checking pixels in the estimated outline of the shadow from the image so as to detect effective pixels corresponding to the shadow area,
calculate a model for a center line of a club shaft of the golf club from data corresponding to the specified shadow area of the golf club, and
detect the golf club by converting the two-dimensional coordinates according to the model for the center line of the club shaft into three-dimensional coordinates.
